(19) United States
(12) Patent Application Publication
(10) Pub. No.: US 2010/0281839 A1
(43) Pub. Date: Nov. 11, 2010

(54) Comminution device comprising at least one rotor and at least one counter-blade for the comminution of organic materials

(76) Inventor: Artur Willibald, Herdwangen (DE)

Correspondence Address: LAMBERT & ASSOCIATES, 92 STATE STREET, BOSTON, MA, 02109-2004, US

(21) Appl. No.: 11/989,043

(22) PCT Filed: Jul. 12, 2006
(86) PCT No.: PCT/EP2006/006823

§ 371 Date: Mar. 2, 2009

(30) Foreign Application Priority Data
Jul. 20, 2005 (DE) 10 2005 034 491.7

(51) Int. Cl. A01D 43/06

(52) U.S. Cl. 56/153

(57) ABSTRACT

The invention relates to a comminution device comprising at least one rotor and at least one counter-blade for the comminution of organic materials, earths, plant cultures or similar, wherein the organic material may be comminuted and transported to a trap device by means of the at least one rotor.

The present invention relates to a comminution device with at least one rotor and at least one counter blade for comminuting organic materials, soils, plant cultures, or the like.

In prior-art comminution devices it is disadvantageous that they do in fact comminute soil but the material being comminuted remains on the ground.

A corresponding enrichment of cultures as well as a gain in biomass is not possible with prior-art comminution devices.

In addition, the comminuted organic material is not thoroughly comminuted and remains on the ground. This is undesirable in the case of certain cultures since the comminuted material is infested by vermin which can once again damage newly growing cultures.

On the other hand, comminuted organic material is of high caloric value and can be processed for re-use, burning, reprocessing into pellets, briquettes, and so on. For this, it is necessary that there is as thorough a comminution of the organic material as possible so that little material to be comminuted remains on the ground and the yield in organically usable comminuted material is optimized. This is not the case with prior-art comminution devices.

The present invention is based on the objective of providing a comminution device of the type stated in the introduction, where said comminution device eliminates the stated disadvantages and where, with said comminution device, organic material will be picked up from the ground, comminuted, and transported off in one operational step in a simple and economical manner.

In addition, the comminution and pick-up of the comminuted organic material will be optimized so that a comminution and release of organic materials is possible in only one operational step.

The features of the characterizing clause of claims 1 and 2 lead to the realization of this objective.

In the present invention it has proven itself particularly advantageous to provide a comminution device which can be attached to any pulling and pushing vehicle, such as a tractor, mulcher, ground-processing device, or the like. Therein a rotor is driven, e.g. via Cardan shafts, its own drive devices, hydraulics, servomotors, toothed belts, and so on, in the direction opposite to the direction of travel, where the rotor can be formed as a comminution rotor, step rotor, etc. and comprises a plurality of the same or different comminution tools which work together with corresponding counter blades which are disposed in a housing of the comminution device.

Therein the rotor rotates in its rotational direction in the area of the ground corresponding to the direction of travel X and thereby picks up the material to be comminuted via a comminution gap, comminutes organic material in the comminution gap between the housing and the rotor element, and then feeds the comminuted organic material directly to a pick-up device connected behind the rotor and comprising an integrated conveyor device. By means of the conveyor device, which can be formed as a spindle, transport belt, conveyor screw, or the like, the comminuted organic material is discharged from the comminution device and in given cases then delivered, by means of a delivery unit, to a receiving vehicle for organic material.

It is also advantageous in the present invention that, due to the arrangement of the rotor, of the housing, and of the pick-up device, within the comminution gap a comminution interval which is as long as possible is provided for the most complete comminution of the organic material and immediately after the comminution the comminuted organic material is fed to the pick-up device via a feed channel.

In this connection, the pick-up device can be opened or closed in the manner of a tank in order to pick up the comminuted material and transport it further.

Along with this, it should also be considered that the pick-up device be provided with appropriate sieve-like perforations in order, for example, to return fine earth or soil material to the ground once again or to disperse the organic material as widely as possible.

If the finest comminution is not absolutely necessary or organic material which is easier to comminute is being processed, then it is also conceivable that in a wider comminution device the pick-up device is also disposed above the rotor in order to ensure that from there, in given cases, the comminuted organic material is transported off directly by means of the conveyor device into a container, a vehicle, or the like. This is also intended to lie within the scope of the present invention.

It is furthermore advantageous in the present invention that the organic material is comminuted in one operational step by means of the rotor and due to the motion of the rotor in the direction of travel, as seen from the ground, not only a pickup but rather also a rapid comminution and feeding of organic material into the comminution gap is ensured. Accordingly, there is a comminution of the organic material in the gap and then the comminuted material is passed on directly to a pick-up device with an integrated conveyor device for further transport.

In so doing, the comminuted organic material is displaced or pressed down via baffle plates or the like only indicated here and picked up by the rotor and fed to the comminution device.

In an additional comminution device according to the present invention at least one transverse conveyor device is connected in front of the rotor, said transverse conveyor device preferably being formed as a bucket wheel. The axis of rotation of the bucket wheel is preferably aligned so as to be perpendicular to the axis of the rotor. The bucket wheel sits in a housing which is connected to the housing of the motor in order to discharge the comminuted organic material laterally.

Along with this, several individual bucket wheels disposed so as to be adjacent in the radial direction can be disposed as transverse conveyors in order to discharge comminuted material in one and/or the other direction, said material having been delivered in the radial direction by the rotor.

In the case of rotors which are formed to be very long, it is also possible to consider using a conveyor screw, a conveyor belt, or the like as an additional conveyor to the bucket wheel, said additional conveyor feeding comminuted material to the bucket wheel for lateral discharge.

Additional advantages, features, and details of the invention follow from the subsequent description of preferred embodiment examples as well as with the aid of the drawings. These show in

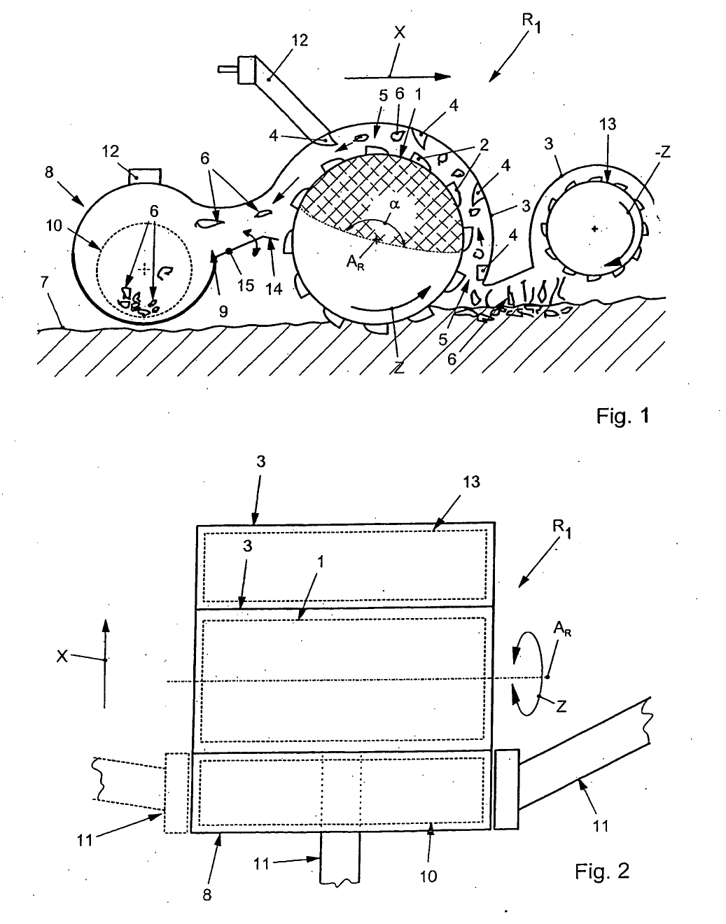

FIG. 1 a schematically represented side view of a comminuting device,

FIG. 2 a schematically represented top view of the comminution device according to FIG. 1 with several possible delivery units,

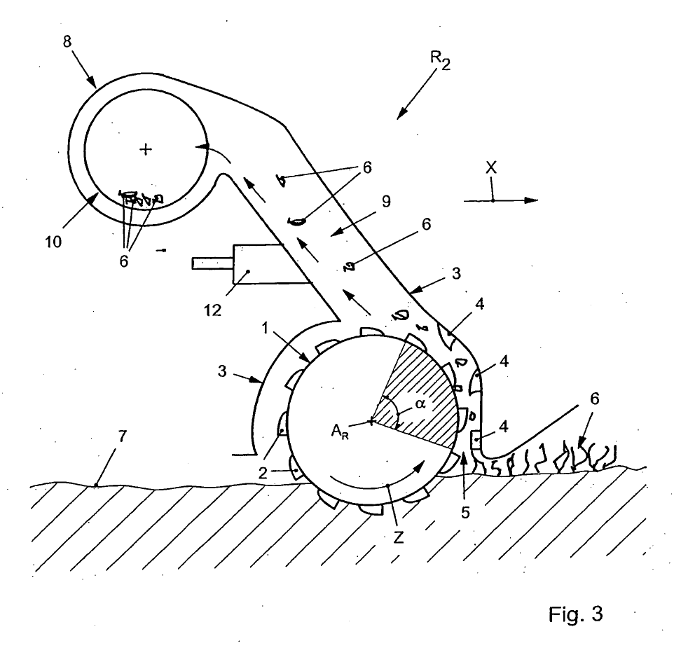

FIG. 3 a schematically represented side view of an additional embodiment example of an additional comminution device according to FIG. 1,

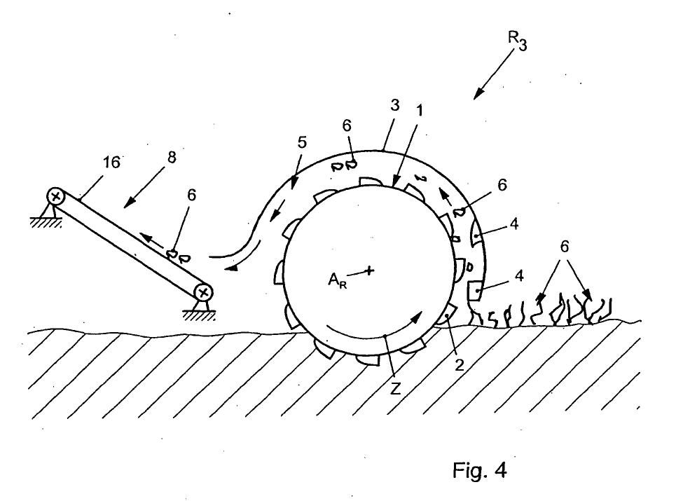

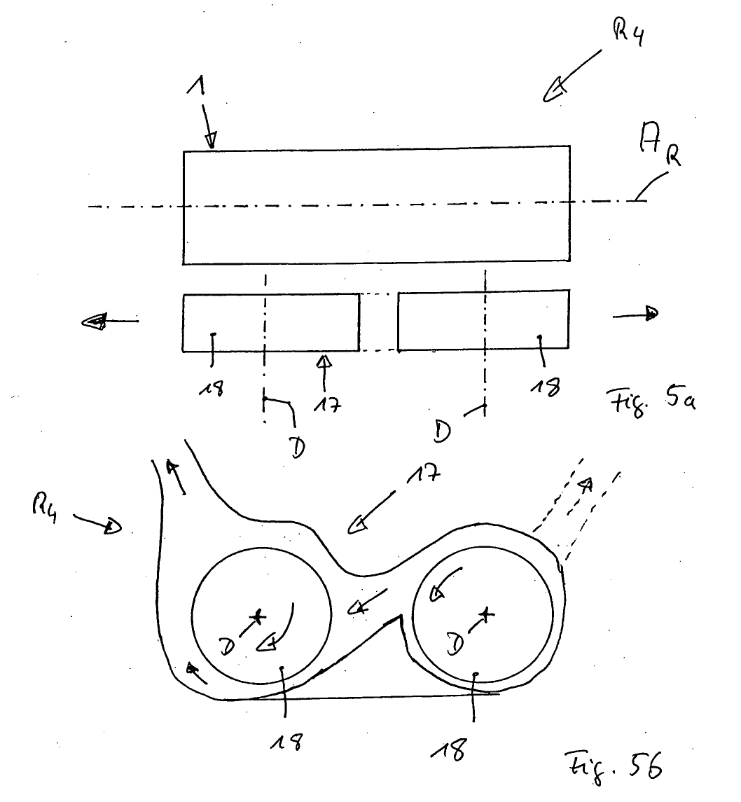

FIG. 4 a schematically represented side view of an additional embodiment example of an additional comminution device according to FIG. 1,

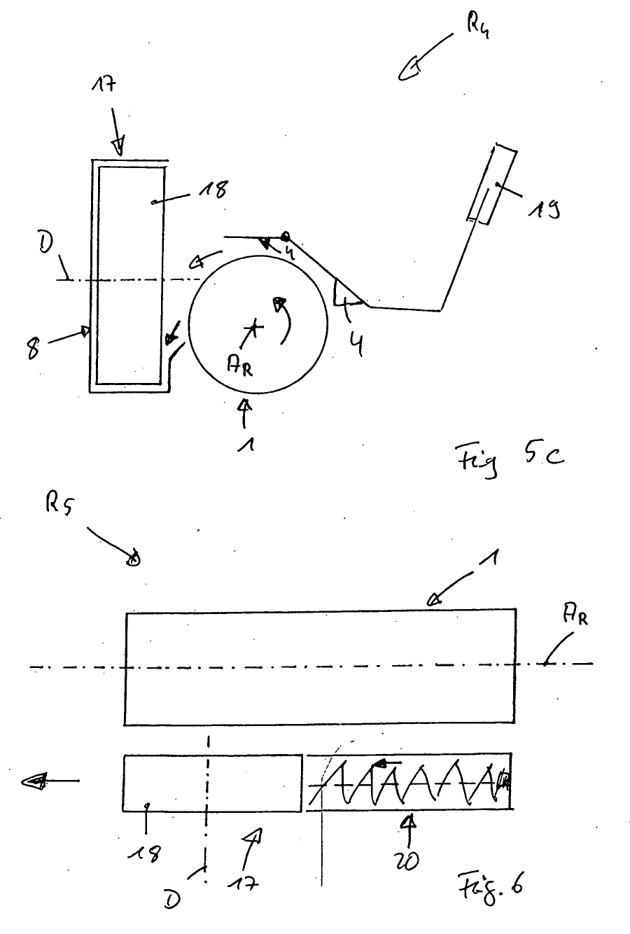

FIG. 5a a schematically represented top view of still another embodiment example of an additional comminution device according to FIG. 1,

FIG. 5b a schematically represented front view of the area of a transverse conveyor device of the comminution device according to FIG. 5a ,

FIG. 5c a schematically represented side view of the comminution device according to FIG. 5a ,

FIG. 6 a schematically represented top view of still another embodiment example of the comminution device according to FIG. 5a as an additional embodiment example.

According to FIG. 1 a comminution device R₁ according to the invention comprises a rotor 1, which is preferably formed as a comminution rotor, and a plurality of comminution tools 2 not represented here in more detail.

The rotor 1 is driven around a rotor axis A_{R}, e.g. via deviating gears, Cardan shafts, toothed belts, or the like by a vehicle or an integrated drive.

In so doing, the rotor 1 is driven around a rotor axis A_{R} in a rotational direction Z, which, as seen from the ground, runs in the same direction as a direction of travel of the comminution device R₁.

The rotor 1 is at least partially surrounded by means of a housing 3, where in the interior part of the housing 3 one, or a plurality, of counter blades 4 are provided which work together with the comminution device 2 of the rotor 1.

Through the rotational direction Z of the rotor 1, as seen from the ground 7, with the direction of travel X, the organic material to be comminuted, such as branches, soils, plant cultures, or the like, is picked up by the rotor 1 and its comminution tools 2 and transported in a comminution gap 5 between the rotor 1 and the housing 3 for comminution on the counter blades 4.

Furthermore, it has proven itself advantageous to move the rotor 1 with a rotational direction Z running in the same direction as the direction of travel X via a pulling vehicle, tractor, or the like in order to comminute organic material 6 in the comminution gap 5.

So that the comminuted organic material 6, the plant cultures, comminuted branches, and chaffed organic substances do not remain on the ground 7 after the comminution, in the present invention a pick-up device 8 is attached, preferably directly, to the rotor 1, in particular directly to the housing 3 in the direction opposite to the direction of travel X.

Along with this, a feed channel 9 is formed between the gap 5 of the housing 3 and the pick-up device 8, said feed channel conveying or conducting the comminuted material 9 into the pick-up device 8.

Preferably, the housing 3, which essentially accommodates the counter blades 4 and covers the rotor 1 on the outside, transitions into the pick-up device 8.

In the pick-up device 8 at least one conveyor device 10 is used in an integrated manner, said conveyor device serving to transport off the comminuted organic material 6.

Preferably, the conveyor device 10 is formed as a transverse conveyor device, such as, for example, as a spindle, transport belt, blower, or the like.

In this way, for example, comminuted organic material 6 which is not supposed to be returned to the ground 7 can be gathered up and discharged via the conveyor device 10 as is represented in FIG. 2, for example, at the front side to the delivery unit 11. The delivery unit 11 can be formed as a transport belt, transport unit, blower, spindle, conveyor screw, or the like to feed the comminuted organic material 6 from the pick-up device 8 via the conveyor device 10 to the delivery unit 11, which, for example, is connected to a separate container, vehicle, or the like.

In this connection, it intended to lie within the scope of the present invention that the delivery unit attaches, on one and/or the other side, to the conveyor device 10, or is disposed therebetween, in order, for example, to feed, with an appropriate loading surface and pick-up capability for comminuted material, said comminuted organic material 6 directly to the pulling vehicle.

In addition to this, the comminution device R₁, as is indicated in FIG. 1, can be connected via corresponding holding elements 12 to a pulling or pushing vehicle, tractor, mulcher, etc. and can be driven via Cardan shafts, deviating shafts, or the like.

Furthermore, it is advantageous in the present invention that, e.g. in the case of a horizontal arrangement of the rotor 1 and pick-up device 8 in sequence, the housing 3, in particular the rotor 1 in the range of an angle α of approximately 90° to 220°, provides a long comminution interval in the area of the periphery of the rotor 1 or the interior peripheral surface of the housing 3 in order to permit as thorough a comminution of the organic material 6 as possible.

Thereby, a comminution interval in the comminution gap 5 is enlarged in order to ensure a fine comminution of organic material.

Furthermore, for a precomminution, an additional rotor 13 can be connected, in such a manner that it can rotate, also about a rotor axis A_{R}, in front of the rotor 1 in order, for example, to precomminute larger organic material, bushes, shrubs, or the like and feed them, precomminuted, to the rotor 1.

In this connection it has proven itself advantageous that, if the rotor 13 should be connected in front of the rotor 1, it moves or is driven in a rotational direction −Z, which is in the opposite direction to that of the rotor 1.

The rotor 13 can, however, be omitted in given cases, even in the case of lower cultures. Let the invention not be restricted thereto. Thus, the additional rotor 13 connected in front, as is indicated in FIG. 2 merely by a dotted line, can optionally be connected or mounted in front of the rotor 1. As can furthermore be seen from FIG. 1, a flap element 14 can be provided between the pick-up device 8 and the rotor 1, said flap element being pivotable about a hinge 15 in order, for example, to reroute the comminuted organic material 6 to the ground 7 during operation, or in given cases to ensure a rerouting if overfilling occurs. The flap element 14 can also be opened manually or automatically during operation for maintenance purposes, cleaning purposes, emptying purposes, or the like.

Furthermore, it has proven itself advantageous in the present invention that the pick-up device 8 can be formed in the manner of a tank, in given cases open upwards, in order to pick up the comminuted organic material 6 there.

In this connection, it is intended to lie within the scope of the present invention that the pick-up device 8, in particular the tank-like pick-up device 8, can be provided with appropriate perforations in the manner of a sieve in order to free the organic material of soil remnants or soil particles, which then can be discharged once again, via the perforations or sieve-like structure of the pick-up device 8, directly over the ground 7.

In another embodiment example of the present invention and according to FIG. 3 a comminution device R₂ is shown in which the pick-up device 8 with the conveyor device 10 is not disposed behind the rotor element 1 but rather is provided above the rotor element 1.

From this arrangement an angle α is reduced, or in the range of angles for comminution in the comminution gap 5 a comminution interval is reduced around the periphery of the rotor 1 in a somewhat smaller range of angles of approximately 20° to 90°.

For easily comminuted organic material it can be advantageous that the discharge and delivery of comminuted organic material 6 into the pick-up device 8 and via the conveyor device 10 is simplified, e.g. in a direct pick-up container. In given cases, the delivery unit 11 can be omitted. This is also intended to lie within the scope of the present invention.

Also here it is advantageous that the rotor 1 moves in the same rotational direction Z relative to the direction of travel X, as seen from the ground 7, and picks up the material 6 to be comminuted, feeds it to the comminution gap 5 between the housing 3, comminutes it between the counter blades 4, and delivers it to the pick-up device 8. This is also intended to lie within the scope of the present invention.

According to FIG. 4 an additional comminution device R₃ comprises a rotor 1, as is described approximately according to FIG. 1, said additional comminution device comprising a plurality of comminution tools 2 which work together with corresponding counter blades 4 which have been introduced [into] the housing 3 encircling the rotor 1. In this additional comminution device, in order to comminute organic material 6 the rotor 1 can be driven according to the rotational direction Z which is represented.

Along with this, in the manner already described, a pick-up device 8 is attached directly to the housing 3 or to the rotor 1 in order to directly discharge comminuted organic material 6.

In a preferred embodiment example the pick-up device 8 is formed as a conveyor device 16 in the housing 3 or the rotor 1 as an independent unit of a comminution device R₃, in particular as a conveyor belt. In so doing, the conveyor device 16 is a fixed component of the comminution device R₃. For this, the comminuted organic material 6 can be discharged and fed to a horizontal vehicle pick-up container or the like.

In the embodiment example according to FIG. 5a a comminution device R₄ is shown in which a transverse conveyor device 17 is attached directly to the rotor 1, as is represented schematically.

The transverse conveyor device 17 can, for example, be formed from two bucket wheels 18 which are disposed so as to be adjacent and are accommodated in a common housing, as is also represented in particular in FIG. 5b.

The distinctive feature of the transverse conveyor device 17 is the fact that the axes of rotation D of the bucket wheels 18 run approximately perpendicular to the rotor axis A_{R}.

In connection with this, the individual adjacent bucket wheels 18 of the transverse conveyor device 17 can be driven individually or jointly.

These convey comminuted goods laterally, as is represented in the arrow direction in FIG. 5a, either to one and/or the other side, depending on the rotational direction of the bucket wheels 18 of the transverse conveyor device 17.

There the comminuted organic material can be easily delivered to an additional delivery, transport belt, delivery unit, vehicle and so on.

From FIG. 5c it can be seen that the transverse conveyor device 17 attaches to the rotor 1 in the axial direction and the material comminuted by means of the counter blades 4 arrives directly in a pick-up device 8 of the transverse conveyor device 17 and from there is discharged to one and/or the other side.

The counter blades 4 can be mounted, in given cases, in the manner of a hinge and can be moved via a corresponding pushing device 19, not represented here, against the rotor 1 to change the size of the organic material and substances to be comminuted.

In the embodiment example of the present invention according to FIG. 6 a comminution device R₅ is indicated in which a transverse conveyor 20 is connected in front of the transverse conveyor device 17 with bucket wheel 18, said transverse conveyor then delivering the organic comminuted material of the rotor 1 to the bucket wheel 18 for lateral discharge. For example, conveyor screws, belts, and so on can be provided as the transverse conveyor 20 in order, in the case of rotors 1 formed so as to be very wide, to use only a single bucket wheel 18, which then receives the material comminuted over the remaining length of the rotor 1 via the transverse conveyor 20 for lateral discharge.

In this way a transverse conveyor device 17 can be connected behind the rotor 1, said transverse conveyor device being structured in a very simple manner with respect to apparatus, being inexpensive to produce, and operating effectively.

Depending on the arrangement of the transverse conveyor 20 and bucket wheel 18, a discharge of the comminuted material to one or the other side can be ensured.

1. Comminution device with at least one rotor and at least one counter blade for comminuting organic materials, soils, plant cultures, or the like, characterized by the fact that the organic material can be comminuted by means of at least one rotor and can be fed to a pick-up device.

2. Comminution device with at least one rotor and at least one counter blade for comminuting organic materials, soils, plant cultures, or the like, characterized by the fact that a pick-up device (8) for the comminuted material is associated with the at least one rotor, where in said pick-up device at least one conveyor device, in particular a transverse conveyor device for discharging the comminuted organic material, is provided.

3. Comminution device according to claim 2, characterized by the fact that the rotor comprises a plurality of the same or different comminution tools, which work together with corresponding counter blades of an encircling housing.

4. Comminution device according to claim 3, characterized by the fact that the rotor is driven in the same direction as the direction of travel or a direction of motion of the comminution device as seen from the ground.

5. Comminution device according to claim 4, characterized by the fact that the rotor is formed in particular as a comminution rotor and due to its rotational direction relative to the direction of travel is driven in such a manner that it picks up material, where the housing diverts or delivers the comminuted organic material into a pick-up device.

6. Comminution device according to claim 5, characterized by the fact that the pick-up device is disposed so as to be connected directly in front of the rotor in the direction opposite to the direction of travel.

7. Comminution device according to claim 6, characterized by the fact that pick-up device comprises at least one conveyor device, in particular a transverse conveyor device which serves to continuously or discontinuously transport off comminuted organic material.

8. Comminution device according to claim 7, characterized by the fact that the conveyor device transports the comminuted organic material out at its front on one side or on both sides, or the at least one conveyor device transports the comminuted organic material out of the pick-up device approximately in its center.

9. Comminution device according to claim 8, characterized by the fact that to the conveyor device, in particular to the transverse conveyor device, a delivery unit, in particular a transport unit for the continuous or discontinuous withdrawal of the comminuted organic material, is attached, or can be attached.

10. Comminution device according to claim 9, characterized by the fact that the delivery unit is formed as a transport unit, transport belt, blower, or the like which conveys the comminuted organic material to a separate receiving container, car, transport car, or the like.

11. Comminution device according to claim 10, characterized by the fact that due to the corresponding arrangement of the conveyor device, in particular due to the corresponding arrangement of the housing around the rotor it is possible to choose a comminution interval with, in given cases, a plurality of counter blades.

12. Comminution device according to claim 11, characterized by the fact that the rotor, in particular the comminution rotor and the pick-up device with an integrated conveyor device, are spaced so as to be approximately adjacent to and parallel to one another, where these are connected via a common feed channel.

13. Comminution device according to claim 11, characterized by the fact that the pick-up device with, in given cases, an integrated conveyor device is disposed above the rotor axis of the rotor, where a comminution interval between the housing and rotor is reduced and the pick-up device and the rotor or the housing are connected via a common feed channel.

14. Comminution device according to claim 13, characterized by the fact that the pick-up device is formed at least in part in the manner of a sieve.

15. Comminution device according to claim 14, characterized by the fact that the pick-up device is formed as a conveyor device, in particular as a conveyor belt.

16. Comminution device according to claim 15, characterized by the fact that connected in front of the rotor, for precomminution, there is a rotor which is driven, or can be driven, in a direction opposite to the drive direction for the rotor.

17. Comminution device according to claim 16, characterized by the fact that between the rotor and the pick-up device at least one manually and/or automatically actuable flap element is provided in order to feed comminuted organic material directly to the ground once again, where the at least one flap element can be pivoted about a hinge.

18. Comminution device according to claim 17, characterized by the fact that attached to the rotor is at least one transverse conveyor device which comprises at least one bucket wheel and/or at least one transverse conveyor.

19. Comminution device according to claim 18, characterized by the fact that the at least one axis of rotation of the bucket wheel is aligned approximately perpendicular to the rotor axis.

20. Comminution device according to claim 19, characterized by the fact that, via at least one bucket wheel and/or at least one transverse conveyor, comminuted material can be discharged laterally to one and/or the other side nearly laterally next to the rotor.

21. Comminution device according to claim 20, characterized by the fact that in the housing, in particular in the area of the counter blades, a pressing device is allocated, which sets a distance of the counter blades relative to the comminution tools of the rotor in a manner such that said distance can be varied.
